(19) United States
(12) Patent Application Publication
(10) Pub. No.: US 2014/0346782 A1
(43) Pub. Date: Nov. 27, 2014

(54) MICRO POWER GENERATOR AND POWER GENERATION METHOD USING LIQUID DROPLET

(71) Applicant: Pusan National University Industry-University Cooperation Foundation, Pusan (KR)

(72) Inventors: Hyuk Kyu PAK, Busan (KR); Jong Kyun Moon, Busan (KR); Kyung Chun Kim, Pusan (KR); Sang Youl Yoon, Busan (KR); Hyung Dong Kim, Pusan (KR); Jaeki Jeong, Pusan (KR); Dongyun Lee, Pusan (KR)

(73) Assignee: Pusan National University Industry-University Cooperation Foundation, Pusan (KR)

(21) Appl. No.: 13/900,829

(22) Filed: May 23, 2013

(51) Int. Cl. F03B 13/00

(52) U.S. Cl. CPC F03B 13/00
USPC 290/1 R

(57) ABSTRACT

The present invention relates to a micro power generator and power generation method using a liquid droplet to produce electricity using alternating current (AC) power induced by changing the contact areas of a liquid droplet between two electrode plates by vibration. The micro power generator according to the present invention includes first and second electrode plates positioned adjacent to and facing each other; an ion-containing liquid droplet positioned between the first and second electrode plates; and a power generation unit for producing electricity using AC voltage generated between the first and second electrode plates while as at least one of the first and second electrode plates is vibrated, a contact area between each of the first and second electrode plates and the liquid droplet changes with time.

### BACKGROUND OF THE INVENTION

1. Field of Invention

The present invention relates to a micro power generator, and more particularly, to a micro power generator and power generation method using a liquid droplet to produce electricity by vibrating the liquid droplet.

2. Description of the Prior Art

Batteries, which are widely used as power sources of various portable electric devices, various sensors and the like, are difficult to be stored and have limitation in the lifespan of themselves. As an example, lithium batteries widely used in various sensors, such as intelligent wireless pressure sensors used in a tire pressure monitoring system (TPMS) and gas monitoring sensors, have their limited lifespan and are difficult to be stored, so that self discharge is increased and the lifespan is reduced if the operating temperature increases.

Meanwhile, as an alternative energy source departing from the battery type, recently, a piezoelectric phenomenon is widely used as disclosed in Korean Patent Application Publication Nos. 2013-0017343, 2013-0005445, 2009-0006250, 2007-0014328, and 2011-0110444, Japanese Patent Application Publication Nos. 2012-234925 and 2012-175890, and the like. The piezoelectric phenomenon causes positive or negative charges to be generated on the surface in proportion to external force when pressure is applied to a crystal such as quartz or tourmaline in a certain direction. Deformation may also occur when voltage is applied, as a reverse phenomenon. Since such piezoelectric or reverse phenomena relate to the mechanical deformation and electric energy conversion, they have been applied to a microphone or phonograph. Applications of such a piezoelectric phenomenon are not limited to the foregoing, and it is applied to the field from a quartz crystal widely used in electric devices, recently to a high performance filter for wireless communications using a surface acoustic wave (SAW) or a film bulk acoustic resonator (FBAR). Furthermore, along with a recent interest in clean energy, a self power generator using a piezoelectric thick film and the like have been unveiled.

Thus, studies of alternative energy sources departing from batteries are recently in progress, and as various portable electric devices are widely used, the necessity for new kinds of micro power generators suitable therefor is still more increased. However, there is a problem in that except for the means using the piezoelectric phenomenon as described above, there is few generating means having a high potential in terms of practical use and power generation efficiency to be used in portable electric devices.

### SUMMARY OF THE INVENTION

The present invention is conceived to solve the energy source required as above. An object of the present invention is to provide a micro power generator and power generation method using a liquid droplet to produce electricity using alternating current (AC) power induced by changing the contact areas of a liquid droplet between two electrode plates by vibration.

According to an aspect of the present invention for achieving the objects, there is provided a micro power generator using a liquid droplet includes first and second electrode plates positioned adjacent to and facing each other; an ion-containing liquid droplet positioned between the first and second electrode plates; and a power generation unit for producing electricity using AC voltage generated between the first and second electrode plates.

Here, the ion-containing liquid droplet may include water or an electrolyte solution.

In addition, as at least one of the first and second electrode plates is vibrated, a change in distance between the electrode plates may cause a contact area between each of the first and second electrode plates and the liquid droplet to change with time.

Further, an electrical double layer may be generated in the contact area between each of the first and second electrode plates and the liquid droplet.

Furthermore, a change in the contact area between each of the first and second electrode plates and the liquid droplet may cause a change in electric capacity in the electrical double layer.

Also, the vibration of the first or second electrode plate may be generated using living vibration through direct or indirect movement of a user or movement caused by a vehicle.

The micro power generator may further include a vibrating device for vibrating at least one of the first and second electrode plates at a constant frequency.

In addition, a surface of at least any one of the first and second electrode plates, with which the liquid droplet is in contact, may be provided with hydrophobic properties.

Here, a surface of at least any one of the first and second electrode plates, with which the liquid droplet is in contact, may be coated with a hydrophobic material.

Further, a surface of at least any one of the first and second electrode plates, with which the liquid droplet is in contact, may be formed in a shape having hydrophobic properties.

Furthermore, a surface of at least any one of the first and second electrode plates, with which the liquid droplet is in contact, may have a concave and convex portion formed thereon to enlarge a surface area capable of contacting with the liquid droplet.

Moreover, a surface of at least any one of the first and second electrode plates, with which the liquid droplet is in contact, may have a plurality of fine protrusions formed thereon to enlarge a surface area capable of contacting with the liquid droplet.

Also, a surface of at least any one of the first and second electrode plates, with which the liquid droplet is in contact, may have a plurality of fine recesses formed thereon to enlarge a surface area capable of contacting with the liquid droplet

Also, a surface of at least any one of the first and second electrode plates, with which the liquid droplet is in contact, may be formed of a hydrophobic material.

In addition, a surface of any one of the first and second electrode plates, with which the liquid droplet is in contact, may be provided with hydrophobic properties, and a surface of the other electrode plate, with which the liquid droplet is in contact, may be provided with hydrophilic properties.

Further, a surface of the first electrode plate, with which the liquid droplet is in contact, may be provided with hydrophobic properties, and a surface of the second electrode plate, with which the liquid droplet is in contact, may be provided with hydrophilic properties, wherein the first electrode plate may be positioned upper than the second electrode plate.

Also, the surface of the second electrode plate, with which the liquid droplet is in contact, may further include a porous layer having a positioning hole formed therein so that the liquid droplet is positioned in the positioning hole, and the layer comprises a hydrophobic material.

In addition, the surface of the second electrode plate, with which the liquid droplet is in contact, may further have a positioning recess formed therein so that the liquid droplet is positioned in the positioning recess corresponding to the positioning hole of the porous layer.

Also, a region between the first and second electrode plates in which the liquid droplet is positioned may air-tight be sealed.

Further, the region sealed between the first and second electrode plates may contain moisture to at least partially prevent the liquid droplet from evaporating.

The micro power generator may further include a first casing coupled to the first electrode plate, a second casing coupled to the second electrode plate, and a sealing member installed between peripheral portions of the first and second casings, so that the first and second electrode plates and the region therebetween are sealably surrounded, wherein the sealing member comprises an elastic material for sealing the region between the first and second casings and coping with a change in distance between the first and second electrode plates.

Also, a surface of at least any one of the first and second electrode plates, with which the liquid droplet is in contact, may be surface-processed to enlarge a surface area.

According to another aspect of the present invention, there is provided a power generation method using a liquid droplet, wherein with an ion-containing liquid droplet being positioned between first and second electrode plates adjacent to and facing each other, electricity is produced using AC voltage generated between the first and second electrode plates by applying vibration to at least one of the first and second electrode plates to change a contact area between each of the first and second electrode plates and the liquid droplet with time. The previously mentioned features may be added to the other aspect.

### BRIEF DESCRIPTION OF THE DRAWINGS

FIG. 1 is a view showing the configuration of a micro power generator using a liquid droplet according to an embodiment of the present invention;

FIGS. 2 and 3 are views illustrating an electrical double layer generated in the micro power generator using a liquid droplet according to the embodiment of the present invention;

FIG. 4 is a graph showing AC voltage generated in the micro power generator according to the embodiment of the present invention;

FIG. 5 is a view showing the configuration in which the micro power generator using a liquid droplet according to the embodiment of the present invention uses a plurality of liquid droplets;

FIG. 6 is a partial view illustrating the configuration of a micro power generator using a liquid droplet according to a first modification of the present invention;

FIG. 7 is a partial view illustrating the configuration of a micro power generator using a liquid droplet according to a second modification of the present invention;

FIG. 8 is a partial view illustrating the configuration of a micro power generator using a liquid droplet according to a third modification of the present invention;

FIG. 9 is a partial view illustrating the configuration of a micro power generator using a liquid droplet according to a fourth modification of the present invention;

FIG. 10 is a partial view illustrating the configuration of a micro power generator using a liquid droplet according to a fifth modification of the present invention;

FIG. 11 is a partial view illustrating the configuration of a micro power generator using a liquid droplet according to a sixth modification of the present invention;

FIG. 12 is an operation view illustrating the operation and change when vibration is applied to the micro power generator using a liquid droplet according to the sixth modification of the present invention;

FIG. 13 is a detailed view showing the more specific configuration of the micro power generator using a liquid droplet according to a seventh modification of the present invention;

FIG. 14 is a sectional view of a second electrode plate illustrating the configuration of a micro power generator using a liquid droplet according to an eighth modification of the present invention; and

FIG. 15 is a perspective view of the second electrode plate according to the eighth modification of the present invention.

### DETAILED DESCRIPTION OF THE PREFERRED EMBODIMENT

A micro power generator and power generation method using a liquid droplet according to embodiments of the present invention will be described with a focus on the micro power generator in detail with reference to the accompanying drawings. Since the present invention may include various modifications and many forms, specific embodiments will be illustrated in the drawings and described in the specification in detail. However, the embodiments are not construed as limiting the present invention to the specific disclosures, but the present invention should be construed to encompass all modifications, equivalents and substitutes included in the technical spirit and scope of the present invention. Throughout the drawings, like reference numerals are used to designate like elements. In the accompanying drawings, the dimensions of elements may be exaggerated for clarity of the present invention or reduced for understanding the schematic configuration.

In addition, the terms, first, second and the like may be used to describe various components, but the components should not be limited to the terms. The above terms are used only for the purpose of distinguishing one component from the other component. For example, a first component may be named as a second component without departing from the scope of the present invention, and similarly, the second component may be named as the first component. Meanwhile, unless defined otherwise, all technical and scientific terms used herein have the same meaning as commonly understood by one of ordinary skill in the art to which the invention belongs. The terms as defined in generally used dictionaries should be construed as having the meanings corresponding to those in the context of the related art and are not interpreted as ideal or excessively formal meanings unless clearly defined herein.

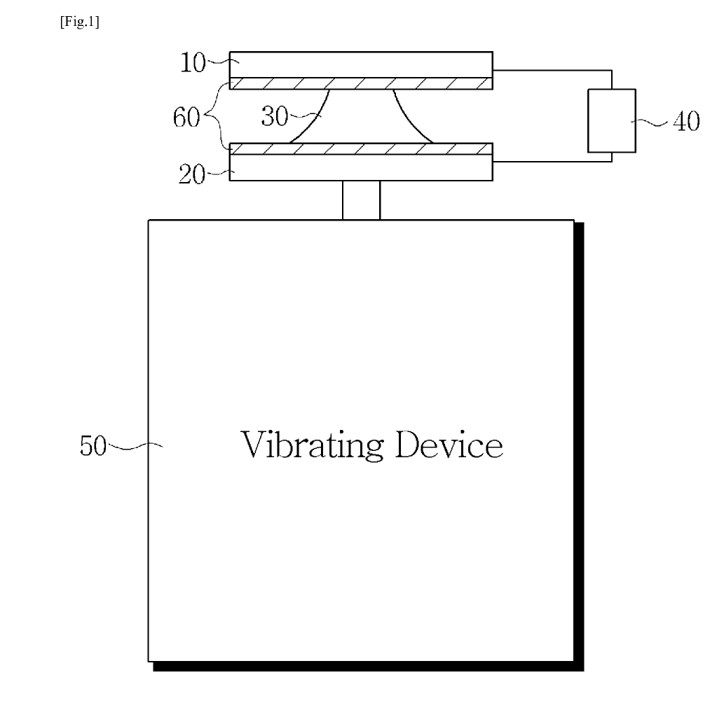

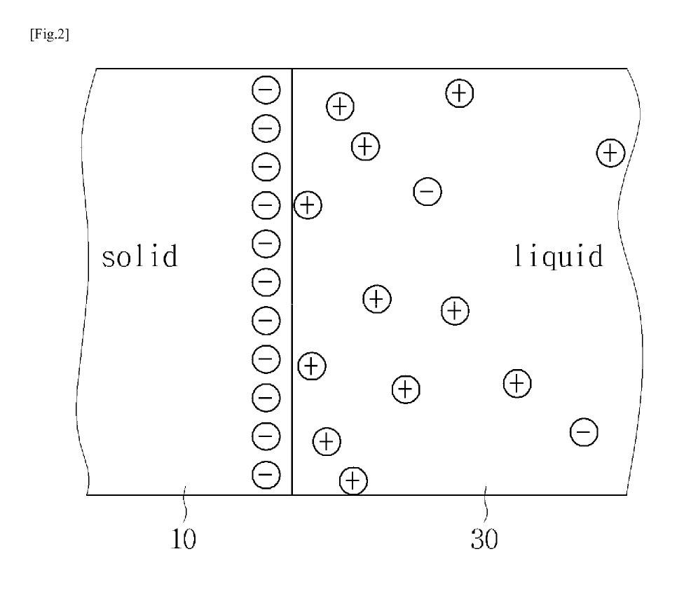

FIG. 1 is a view showing the configuration of a micro power generator using a liquid droplet according to an embodiment of the present invention; FIGS. 2 and 3 are views illustrating an electrical double layer generated in the micro power generator using a liquid droplet according to the embodiment of the present invention.

As shown in FIG. 1, a micro power generator includes first and second electrode plates 10 and 20 positioned adjacent to and facing each other, an ion-containing liquid droplet 30 positioned between the first and second electrode plates 10 and 20, and a power generation unit 40 for producing electricity using AC voltage generated between the first and second electrode plates 10 and 20. The liquid droplet 30 may be composed of pure water. Alternatively the liquid droplet 30 may be composed of an electrolyte solution in which an ionic compound such as sodium chloride (NaCl) is dissolved.

Here, the AC voltage is generated between the first and second electrode plates 10 and 20 in the following manner. That is, a change in distance between the first and second electrode plates 10 and 20 is caused by vibration of at least one of the first and second electrode plates 10 and 20, whereby a contact area between each of the first and second electrode plates 10 and 20 and the liquid droplet 30 changes with time. In this case, the change in the contact area between each of the first and second electrode plates 10 and 20 and the liquid droplet 30 causes a change in electric capacity in an electrical double layer. That is, as shown in FIG. 2, if the electrodes are soaked in a solution, the electrodes and the solution are charged with negative (−) and positive (+) charges, like a capacitor. In this case, the solution of the liquid droplet 30 is discharged with positive charges if the first and second electrode plates 10 and 20 are discharged with negative charges, while the solution of the liquid droplet 30 is discharged with negative charges if the first and second electrode plates 10 and 20 are discharged with positive charges. Accordingly, as shown in FIG. 3, an electrical double layer is exhibited between the electrode and the solution, which is an electric structure, such as a capacitor. Generally, the electrical double layer refers to a boundary, in which in a contact interface of two phases having different compositions from each other, surplus positive and negative charges are continuously distributed in one side and the other side of the interface, respectively, and which satisfies an electrically neutral condition on the whole. In general, if different kinds of materials come into contact with each other, a charge distribution near an interface changes, or polarization occurs due to a difference in movements of charged particles through the interface, which is referred to as an electrical double layer. 0. Stern's theory that when an ion-containing liquid comes into contact with a solid, a portion of charges in the liquid is concentrated at the interface to form a solid phase (Helmholtz's layer) and the other portion is diffusely distributed in the liquid phase is generally recognized. An atmosphere of colloid ions has also a similar structure thereto.

Accordingly, if the first and second electrode plates 10 and 20 are vibrated, the contact area is changed with time, and thus, electric capacity of the electrical double layer changes with time. Then, a potential difference between the first and second electrode plates 10 and 20 changes with time to generate AC voltage. In this case, the vibration of the first and second electrode plates 10 and 20 may be generated using living vibrations such as not only direct movement of a user or indirect movement of a mobile phone or the like, which is caused by the movement of the user, but also movement caused by a vehicle, such as an automobile and a bicycle. Besides, in other embodiment, a vibrating device 50 for generating vibration at a constant frequency is further provided, and the vibration may be generated using the vibrating device 50.

In addition, the power generation unit 40 produces electricity using AC power generated between the first and second electrode plates 10 and 20. In such a procedure, the power generation unit 40 adjusts a level of the voltage produced to a suitable value by means of a resistor.

In this case, the change in the contact area between the electrode plate and the liquid droplet 30 can be adjusted by coating the first electrode plate 10 or the second electrode plate 20 with a material having surface properties which enlarge the change in the contact area with time during the vibration. That is, the surface, with which the liquid droplet 30 is in contact, may be coated with a hydrophobic or hydrophilic material 60, thereby adjusting the change in the contact area between the electrode plate and the liquid droplet 30. For reference, the first and second electrode plates 10 and 20 may be coated with the same material (one of hydrophobic and hydrophilic materials) as the hydrophobic or hydrophilic material 60. On the other hand, the electrode plates may be coated with different materials, i.e., the first and second electrode plates 10 and 20 may be respectively coated with a hydrophobic material and a hydrophilic material, or the first and second electrode plates 10 and 20 may be respectively coated with a hydrophilic material and a hydrophobic material, which will be described in detail later.

In addition, the first and second electrode plates 10 and 20 should be air-tight sealed so that the liquid droplet 30 does not leak out of the electrode plates. The more specific configuration related therewith will be described later.

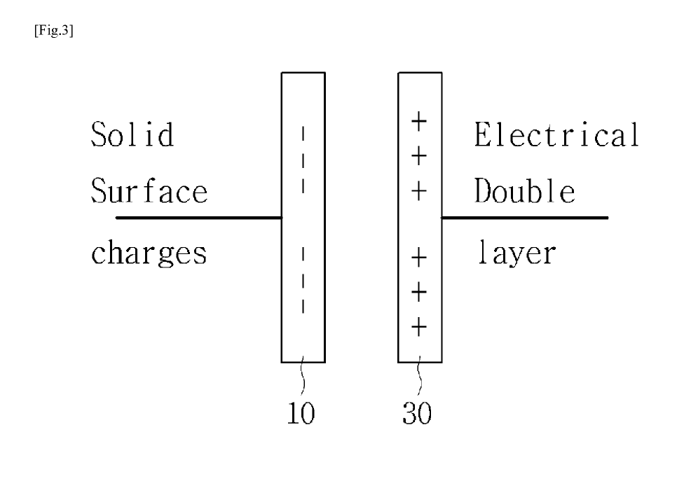

FIG. 4 shows a graph of an AC voltage generated in the micro power generator when the liquid droplet 30 of 40 microliter (μl) is vibrated at 5 Hz. As shown in FIG. 4, it can be verified that in the micro power generator of the present invention, the vibration causes the change in the contact area between the first and second electrode plates 10 and 20 and the liquid droplet 30 to occur and AC voltage is induced by the change in the area.

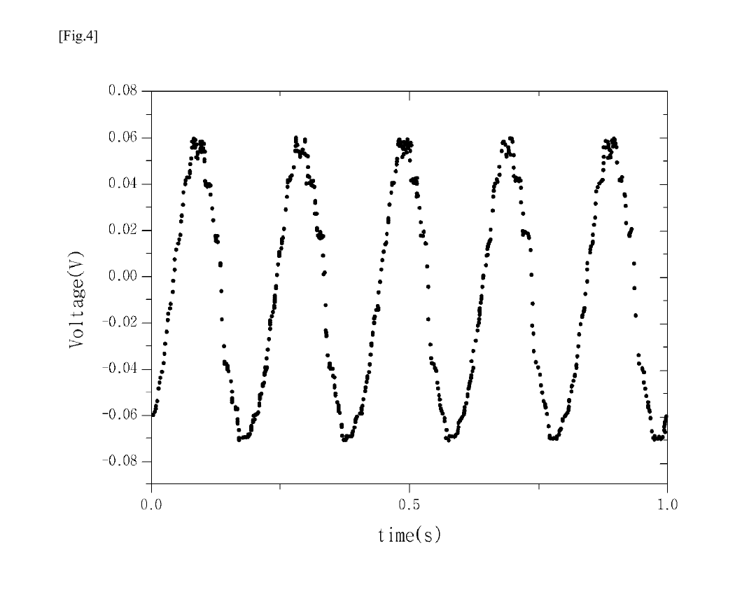

FIG. 5 is a view showing the configuration in which the micro power generator using a liquid droplet according to the embodiment of the present invention uses a plurality of liquid droplets.

As shown in FIG. 5, it is preferred that the liquid droplet 30 provided between the first and second electrode plates 10 and 20 comprise a plurality of liquid droplets 30. This is because when the plurality of liquid droplets 30 are provided, the amount of electric energy and efficiency of the AC voltage produced from the power generation unit 40 can be increased. Meanwhile, as briefly mentioned above, the present invention makes it possible to adjust a change rate of a contact area of the liquid droplet 30 by providing at least any one of the first and second electrode plates 10 and 20 with at least any one of hydrophobic and hydrophilic properties. In addition, at least any one of the first and second electrode plates 10 and 20 may be configured so that a surface area capable of contacting with the liquid droplet 30 is maximized. A variety of modifications configured with a focus on such two phases will be described below.

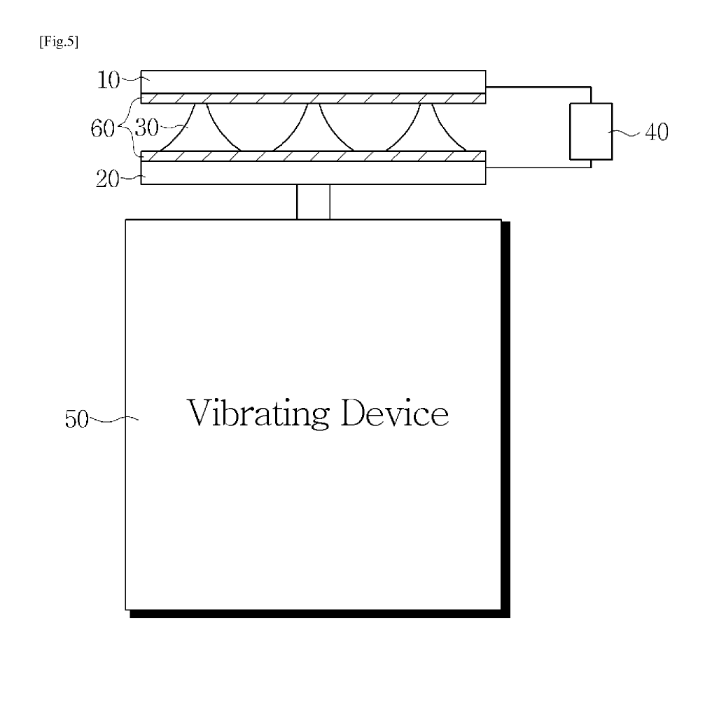

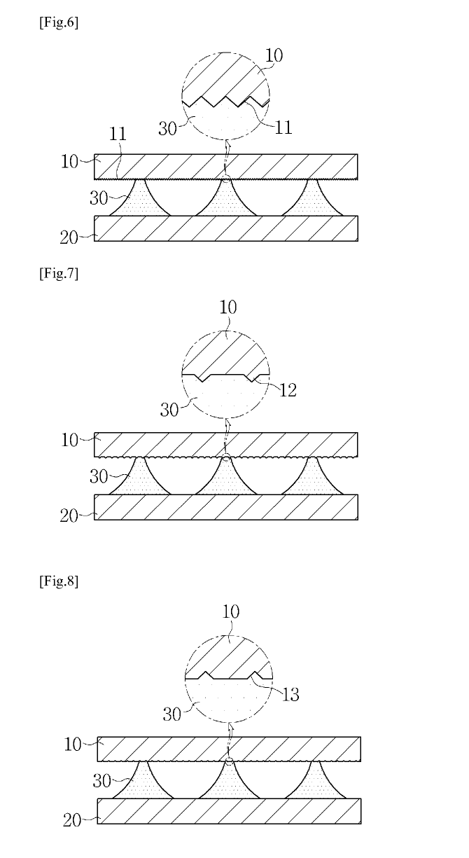

FIG. 6 is a partial view illustrating the configuration of a micro power generator using a liquid droplet according to a first modification of the present invention;

As shown in the figure, according to the first modification of the present invention, a concave and convex portion 11 is formed on a surface of the upper-positioned first electrode plate 10, with which the liquid droplet 30 is in contact. According to the configuration of the first modification, since the first electrode plate 10 is positioned above the second electrode plate 20, the first electrode plate 10, in which a change in contact area with the liquid droplet 30 is more active as compared with the second electrode plate 20, secures a larger surface area capable of contacting with the liquid droplet 30, which makes it possible to expect higher power generation effects.

In addition, the first electrode plate 10 has the concave and convex portion 11 formed thereon, so that it is possible to expect effects caused by not only an increase in its surface area but also hydrophobic or hydrophilic properties. Such effects can be varied depending on a material of the first electrode plate 10 or size and shape of the concave and convex portion 11. For example, the first electrode plate 10 is likely to generally have hydrophobic properties when the size of peaks and valleys of the concave and convex portion 11 is so small that it is in nanometer scale and, on the contrary, to have hydrophilic properties when the size of the peaks and valleys of the concave and convex portion 11 is large.

FIG. 7 is a partial view illustrating the configuration of a micro power generator using a liquid droplet according to a second modification of the present invention.

As shown in the figure, according to the second modification of the present invention, a plurality of fine protrusions 12 are formed on a surface of the upper-positioned first electrode plate 10, with which the liquid droplet 30 is in contact. According to the configuration of the second modification, the first electrode plate 10, in which a change in contact area with the liquid droplet 30 is more active as compared with the lower-positioned second electrode plate 20, secures a larger surface area capable of contacting with the liquid droplet 30, which makes it possible to expect higher power generation effects, in the same way as the first modification.

Even in such a case, it is possible to expect hydrophobic or hydrophilic properties depending on size and density of the fine protrusions 12.

FIG. 8 is a partial view illustrating the configuration of a micro power generator using a liquid droplet according to a third modification of the present invention.

As shown in the figure, according to the third modification of the present invention, a plurality of fine recesses 13 are formed on a surface of the upper-positioned first electrode plate 10, with which the liquid droplet 30 is in contact. According to the configuration of the third modification, the first electrode plate 10, in which a change in contact area with the liquid droplet 30 is more active as compared with the lower-positioned second electrode plate 20, secures a larger surface area capable of contacting with the liquid droplet 30, which makes it possible to expect higher power generation effects, in the same way as the first modification.

Even in such a case, it is possible to expect hydrophobic or hydrophilic properties depending on size and density of the fine recesses 13.

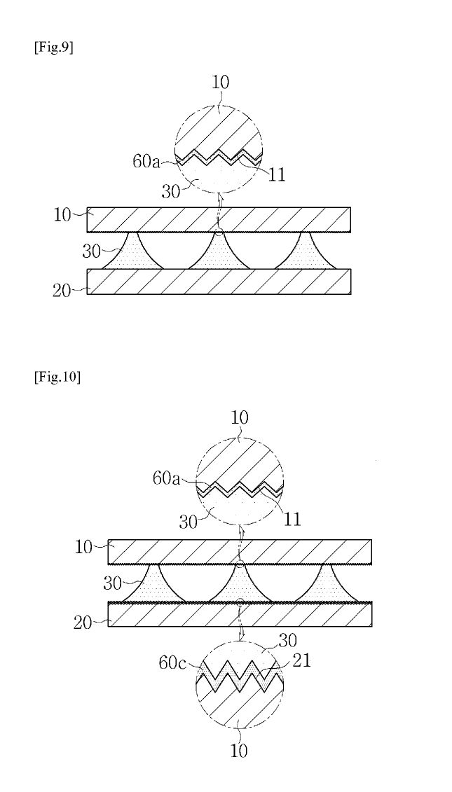

FIG. 9 is a partial view illustrating the configuration of a micro power generator using a liquid droplet according to a fourth modification of the present invention.

As shown in the figure, according to the fourth modification of the present invention, a concave and convex portion 11 is formed on a surface of the upper-positioned first electrode plate 10, with which the liquid droplet 30 is in contact, and a hydrophobic coating layer 60a is formed on the surface of the concave and convex portion 11, so that hydrophobic properties are provided thereto. For example, the first electrode plate 10 may be made of ITO (indium tin oxide) and have the concave and convex portion 11 formed thereon, and the surface thereof may be coated with PTFE (polytetrafluoroethylene) as a hydrophobic material to form the hydrophobic coating layer 60a.

According to the fourth modification, the first electrode plate 10, which has a high change rate of the contact area with the liquid droplet 30 as compared with the second electrode plate 20, secures a larger surface area capable of contacting with the liquid droplet 30, and simultaneously, the surface of the first electrode plate 10 is provided with the hydrophobic properties, whereby a change in the contact area between the first electrode plate 10 and the liquid droplet 30 is effected more smoothly, which makes it possible to expect higher power generation effects.

As described above, the upper-positioned first electrode plate 10, which has a high change rate of the contact area with the liquid droplet 30 during vibration as compared with the second electrode plate 20, secures a larger surface area capable of contacting with the liquid droplet 30 and simultaneously is provided with hydrophobic properties, which makes it possible to maximize power generation effects. In addition, the second electrode plate 20, which has a relatively low change rate of the contact area with the liquid droplet 30 during vibration as compared with the first electrode plate 10, secures a large surface area capable of contacting with the liquid droplet 30 and simultaneously is provided with hydrophilic properties to stably maintain the position of the liquid droplet 30. The configuration having both the above features is considered as the most ideal one. However, since various factors such as contact area, contact angle and adhesion of the liquid droplet 30 with respect to the first and second electrode plates 10 and 20 act as variables on power generation effects, it cannot be concluded that only the configuration considered as the most ideal one as described above can obtain the highest power generation efficiency.

Meanwhile, although the aforementioned first to fourth modifications have been described with the configuration for enlarging a surface area capable of contacting with the liquid droplet 30 and the configuration for providing hydrophobic or hydrophilic properties applied only to the upper-positioned first electrode plate 10, the configurations may be applied to the lower-positioned second electrode plate 20 in the same manner. Some examples thereof will be discussed through the following modifications.

FIG. 10 is a partial view illustrating the configuration of a micro power generator using a liquid droplet according to a fifth modification of the present invention.

As shown in the figure, according to the fifth modification of the present invention, both the upper-positioned first electrode plate 10 and the lower-positioned second electrode plate 20 have the concave and convex portions 11 and 21 formed thereon to maximize surface areas, respectively. In addition, a surface of the first electrode plate 10, with which the liquid droplet 30 is in contact, is provided with hydrophobic properties, and a surface of the second electrode plate 20, with which the liquid droplet 30 is in contact, is provided with hydrophilic properties. Thus, this modification has a differentiated configuration.

Here, in order to provide the first electrode plate 10 with hydrophobic properties, a hydrophobic coating layer 60a obtained by coating the first electrode plate 10 with a hydrophobic material may be provided. Also, in order to provide the second electrode plate 20 with hydrophilic properties, a hydrophilic coating layer 60c obtained by coating the second electrode plate 20 with a hydrophilic material may be provided. For example, the first electrode plate 10 may be coated with PTFE (polytetrafluoroethylene) as the hydrophobic material, and the second electrode plate 20 may be coated with HEMA (hydroxyethylmethacrylate) as the hydrophilic material. However, a method for respectively providing surfaces of the concave and convex portions 11 and 21 with hydrophobic and hydrophilic properties includes various surface modifications, chemical treatments, and the like, in addition to the coating with the corresponding materials, so that it is possible to selectively employ a suitable method for situations without limitation to any one method.

According to the configuration of the fifth modification, the first and second electrode plates 10 and 20 each have a maximized surface area capable of contacting with the liquid droplet 30, during the application of vibration, while the first electrode plate 10 makes a change of the contact area be smoothly effected by the hydrophobic coating layer 60a, and the second electrode plate 20 makes the liquid droplet 30 be stably maintained in its position by the hydrophilic coating layer 60c, so that more improved power generation effects can be expected.

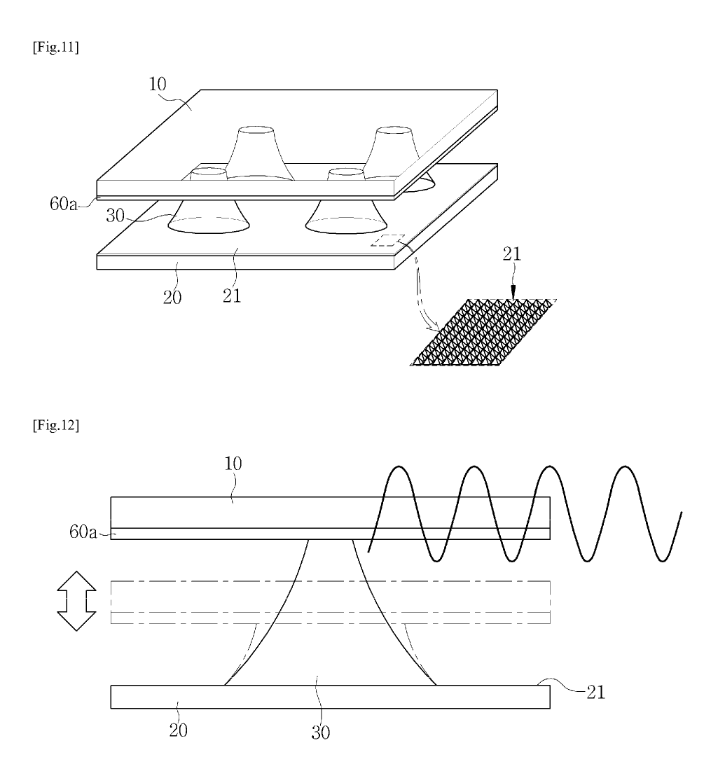

FIG. 11 is a partial view illustrating the configuration of a micro power generator using a liquid droplet according to a sixth modification of the present invention, and FIG. 12 is an operation view illustrating the operation and change when vibration is applied to the micro power generator using a liquid droplet according to the sixth modification of the present invention.

As shown in the figure, according to the sixth modification of the present invention, the upper-positioned first electrode plate 10 is provided with hydrophobic properties and the lower-positioned second electrode plate 20 is configured to secure a larger surface area.

To this end, a surface of the first electrode plate 10, with which the liquid droplet 30 is in contact, has a hydrophobic coating layer 60a formed by coating the surface with a hydrophobic material. In addition, a surface of the lower-positioned second electrode plate 20, with which the liquid droplet 30 is in contact, has a concave and convex portion 21 formed thereon. Although a protruding peak of the concave and convex portion 21 is in the shape of a pyramid as shown in this modification, various shapes such as a triangular cone and a hemisphere are also possible.

In the same way as the first to fifth modifications, the sixth modification is an example of the configuration that the first and second electrode plates 10 and 20 are respectively provided with hydrophobic and hydrophilic properties and a surface area is maximized. The upper-positioned first electrode plate 10 has no maximized surface area but is provided with hydrophobic properties, so that a change of the contact area with the liquid droplet 30 is smoothly made. In addition, the lower-positioned second electrode plate 20 secures a larger surface area to contribute to an increase in power generation efficiency although a change of the contact area with the liquid droplet 30 is not large as compared with the first electrode plate 10. Further, since the surface area can be maximized and simultaneously hydrophilic properties can be obtained by adjusting a size of peaks and valleys of the concave and convex portion 21, it is possible to stably maintain the position of the liquid droplet 30 without additional coating with a hydrophilic material. FIG. 12 shows the operation that a change of the contact area is smoothly obtained in the upper-positioned first electrode plate 10 by the hydrophobic coating layer 60a and the liquid droplet 30 stably maintains its contact and position in the lower-positioned second electrode plate 20 by the concave and convex portion 21 and the hydrophilic properties, during the application of vibration.

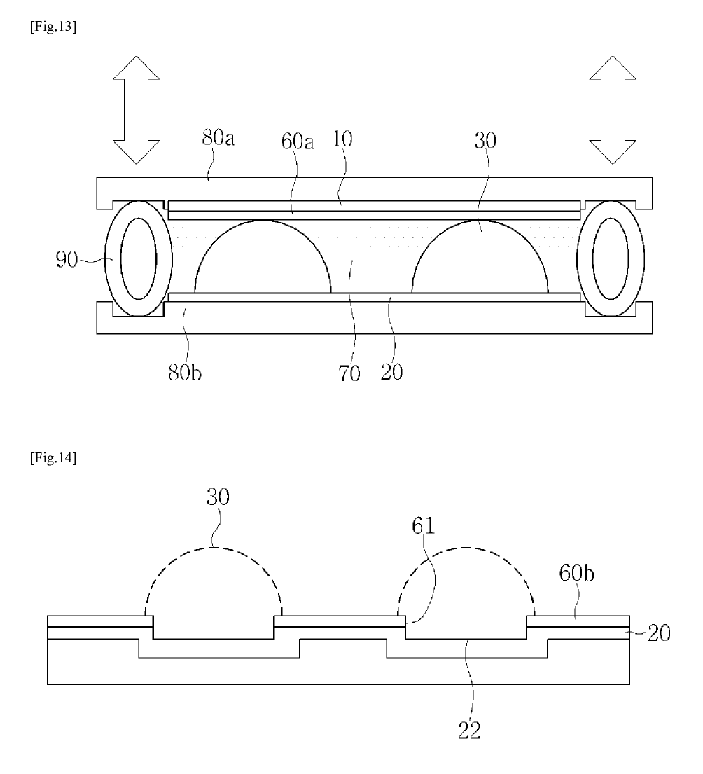

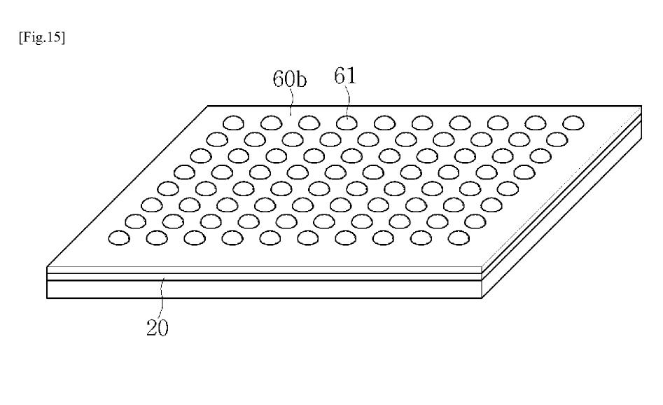

FIG. 13 is a detailed view showing the more specific configuration of the micro power generator using a liquid droplet according to a seventh modification of the present invention.

As shown in the figure, the micro power generator according to the seventh modification of the present invention may further include a first casing 80a surrounding an upper side of the first electrode plate 10 and coupled thereto, a second casing 80b surrounding a lower side of the second electrode plate 20, and a sealing member 90 installed between peripheral portions of the first and second casings 80a and 80b.

The sealing member 90 is made of an elastic material for sealing the region between the first and second casings 80a and 80b and simultaneously coping with a change in distance between the first and second electrode plates 10 and 20 when the vibration is applied.

Here, the sealing member 90 may serve as a shaker, which transmits the vibration applied from the outside to the first and second electrode plates 10 and 20 or has a function of generating a vibration by itself.

Also, a space of the region sealed between the first and second electrode plates 10 and 20 is preferably filled with moisture 70 to maintain humidity for at least partially preventing the liquid droplets 30 from evaporating, and more preferably, a configuration for adjusting the humidity may be further provided. Here, the space between the first and second electrode plates 10 and 20 may be filled with the moisture 70 mostly when the liquid droplets 30 consist of water. If the liquid droplets 30 consist of a material other than water, the space may be naturally filled with a gas of the material.

FIG. 14 is a sectional view of a second electrode plate illustrating the configuration of a micro power generator using a liquid droplet according to a eighth modification of the present invention; and FIG. 15 is a perspective view of the second electrode plate according to the eighth modification of the present invention.

As shown in the figures, according to the eighth modification of the present invention, both the hydrophilic and hydrophobic properties are complexly provided to the lower-positioned second electrode plate 20 to exhibit synergy effects so that the liquid droplet 30 can strongly aggregate to maintain the droplet shape.

To this end, a porous layer 60b having a plurality of positioning holes 61 is further formed on the surface of the second electrode plate 20, with which the liquid droplets 30 are in contact, so that the liquid droplets 30 are positioned in the positioning holes 61, and the porous layer 60b is made of a hydrophobic material. In addition, the surface of the second electrode plate 20, with which the liquid droplets 30 are in contact, has hydrophilic properties and further has positioning recesses 22 formed therein so that the liquid droplets 30 are positioned in the positioning recesses 22 corresponding to the positioning holes 61 of the porous layer 60b.

According to the eighth modification, as can be seen in FIGS. 14 and 15, the liquid droplets 30 are stably positioned in the positioning recesses 22 the positioning holes 61 respectively formed in the second electrode plate 20 and the porous layer 60b and respectively aggregate due to the hydrophobic properties of the porous layer 60b made of the hydrophobic material, whereby each liquid droplet 30 is formed into the shape close to a hemisphere. As compared with the sixth modification, according to such a eighth modification, it is possible to expect effects and functions of more stably maintaining the position of the liquid droplet 30 and allowing the liquid droplet 30 to aggregate into the shape more close to a hemisphere.

Since the micro power generator and power generation method using a liquid droplet according to the present invention as described above can generate power even by small vibration, the power generation is performed using the vibration that can be obtained from various sources including user's living vibrations, so that the micro power generator and power generation method can be applied to the development of an environment-friendly power generation system.

In addition, the present invention can be applied to a small electric device when living vibrations are used, thereby being easily applied to a micro self power generator.

Further, according to the present invention, at least any one of the first and second electrode plates can be provided with at least any one of hydrophobic and hydrophilic properties, thereby changing factors, such as contact angle and contact area between each of the first and second electrode plates and the liquid droplet, thereby being capable of finding higher generating efficiency.

Furthermore, according to the present invention, a surface of at least any one of the first and second electrode plates, with which the liquid droplet is in contact, is surface-processed to form a concave and convex portion, fine protrusions, fine recesses or the like, thereby being capable of maximizing a surface area capable of contacting with the liquid droplet to increase power generation effects.

Although the preferred embodiments of the present invention have been described, the present invention may include various changes, modifications and equivalents. It is clear that the aforementioned embodiments of the present invention can be appropriately modified and equivalently applied. Thus, the aforementioned descriptions should be construed as not limiting the scope of the present invention defined by the following claims.

What is claimed is:

1. A micro power generator using a liquid droplet, comprising:
first and second electrode plates positioned adjacent to and facing each other;
an ion-containing liquid droplet positioned between the first and second electrode plates; and
a power generation unit for producing electricity using AC voltage generated between the first and second electrode plates.

2. The micro power generator according to claim 1, wherein the liquid droplet comprises water.

3. The micro power generator according to claim 1, wherein the liquid droplet comprises an electrolyte solution in which an ionic compound is dissolved.

4. The micro power generator according to claim 1, wherein as at least one of the first and second electrode plates is vibrated, a change in distance between the electrode plates causes a contact area between each of the first and second electrode plates and the liquid droplet to change with time.

5. The micro power generator according to claim 4, wherein an electrical double layer is generated in the contact area between each of the first and second electrode plates and the liquid droplet.

6. The micro power generator according to claim 5, wherein a change in the contact area between each of the first and second electrode plates and the liquid droplet causes a change in electric capacity in the electrical double layer.

7. The micro power generator according to claim 4, wherein the vibration of the first or second electrode plate is generated using living vibration through direct or indirect movement of a user or movement caused by a vehicle.

8. The micro power generator according to claim 1, further comprising a vibrating device for vibrating at least one of the first and second electrode plates at a constant frequency.

9. The micro power generator according to claim 1, wherein a surface of at least any one of the first and second electrode plates, with which the liquid droplet is in contact, is provided with hydrophobic properties.

10. The micro power generator according to claim 9, wherein a surface of at least any one of the first and second electrode plates, with which the liquid droplet is in contact, is coated with a hydrophobic material.

11. The micro power generator according to claim 9, wherein a surface of at least any one of the first and second electrode plates, with which the liquid droplet is in contact, is formed in a shape having hydrophobic properties.

12. The micro power generator according to claim 11, wherein a surface of at least any one of the first and second electrode plates, with which the liquid droplet is in contact, has a concave and convex portion formed thereon to enlarge a surface area capable of contacting with the liquid droplet.

13. The micro power generator according to claim 11, wherein a surface of at least any one of the first and second electrode plates, with which the liquid droplet is in contact, has a plurality of fine protrusions formed thereon to enlarge a surface area capable of contacting with the liquid droplet

14. The micro power generator according to claim 11, wherein a surface of at least any one of the first and second electrode plates, with which the liquid droplet is in contact, may have a plurality of fine recesses formed thereon.

15. The micro power generator according to claim 9, wherein a surface of at least any one of the first and second electrode plates, with which the liquid droplet is in contact, is formed of a hydrophobic material.

16. The micro power generator according to claim 9, wherein a surface of any one of the first and second electrode plates, with which the liquid droplet is in contact, is provided with hydrophobic properties, and a surface of the other electrode plate, with which the liquid droplet is in contact, is provided with hydrophilic properties.

17. The micro power generator according to claim 16, wherein a surface of the first electrode plate, with which the liquid droplet is in contact, is provided with the hydrophobic properties, and a surface of the second electrode plate, with which the liquid droplet is in contact, is provided with the hydrophilic properties, wherein the first electrode plate is positioned upper than the second electrode plate.

18. The micro power generator according to claim 17, wherein the surface of the second electrode plate, with which the liquid droplet is in contact, further comprises a porous layer having a positioning hole formed therein so that the liquid droplet is positioned in the positioning hole, and the layer comprises a hydrophobic material.

19. The micro power generator according to claim 18, wherein the surface of the second electrode plate, with which the liquid droplet is in contact, further has a positioning recess formed therein so that the liquid droplet is positioned in the positioning recess corresponding to the positioning hole of the porous layer.

20. The micro power generator according to claim 9, wherein a region between the first and second electrode plates in which the liquid droplet is positioned is air-tight sealed.

21. The micro power generator according to claim 20, wherein the region sealed between the first and second electrode plates contains moisture to at least partially prevent the liquid droplet from evaporating.

22. The micro power generator according to claim 20, further comprising a first casing coupled to the first electrode plate, a second casing coupled to the second electrode plate, and a sealing member installed between peripheral portions of the first and second casings, so that the first and second electrode plates and the region therebetween are sealably surrounded, wherein the sealing member comprises an elastic material for sealing the region between the first and second casings and coping with a change in distance between the first and second electrode plates.

23. The micro power generator according to claim 1, wherein a surface of at least any one of the first and second electrode plates, with which the liquid droplet is in contact, is surface-processed to enlarge a surface area.

24. The micro power generator according to claim 23, wherein a surface of at least any one of the first and second electrode plates, with which the liquid droplet is in contact, has a concave and convex portion formed thereon.

25. The micro power generator according to claim 23, wherein a surface of at least any one of the first and second electrode plates, with which the liquid droplet is in contact, has a plurality of fine protrusions formed thereon.

26. The micro power generator according to claim 23, wherein a surface of at least any one of the first and second electrode plates, with which the liquid droplet is in contact, may have a plurality of fine recesses formed thereon.

27. A power generation method using a liquid droplet, wherein with an ion-containing liquid droplet being positioned between first and second electrode plates adjacent to and facing each other, electricity is produced using AC voltage generated between the first and second electrode plates by applying vibration to at least one of the first and second electrode plates to change a contact area between each of the first and second electrode plates and the liquid droplet with time.

28. The power generation method according to claim 27, wherein an electrical double layer is generated in the contact area between each of the first and second electrode plates and the liquid droplet.

29. The power generation method according to claim 28, wherein a change in the contact area between each of the first and second electrode plates and the liquid droplet causes a change in electric capacity in the electrical double layer.

30. The power generation method according to claim 27, wherein a surface of at least any one of the first and second electrode plates, with which the liquid droplet is in contact, is provided with hydrophobic properties.

31. The power generation method according to claim 30, wherein a surface of any one of the first and second electrode plates, with which the liquid droplet is in contact, is provided with hydrophobic properties, and a surface of the other electrode plate, with which the liquid droplet is in contact, is provided with hydrophilic properties.

32. The power generation method according to claim 31, wherein one of the first and second electrode plates to which the hydrophobic properties are provided is positioned in an upper side, and the other electrode plate to which the hydrophilic properties are provided is positioned in a lower side.

33. The power generation method according to claim 30, wherein a surface of at least any one of the first and second electrode plates, with which the liquid droplet is in contact, is surface-processed to enlarge a surface area.

34. The power generation method according to claim 27, wherein a surface of at least any one of the first and second electrode plates, with which the liquid droplet is in contact, is surface-processed to enlarge a surface area.

35. The power generation method according to claim 27, wherein a region between the first and second electrode plates in which the liquid droplet is positioned is sealed so that the region contains moisture to at least partially prevent the liquid droplet from evaporating.
